(19) United States
(12) Patent Application Publication
(10) Pub. No.: US 2001/0043424 A1
(43) Pub. Date: Nov. 22, 2001

(54) Servo skewing for track skew

(76) Inventor: Vien Nguyen, San Jose, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/826,685

(22) Filed: Apr. 5, 2001

Related U.S. Application Data
(63) Continuation of application No. 09/075,696, filed on May 11, 1998.

(51) Int. Cl. G11B 21/02; G11B 5/09; G11B 5/596

(52) U.S. Cl. 360/75; 360/48; 360/78.04

(57) ABSTRACT

A removable magnetic cartridge provides enhanced data access. The removable magnetic cartridge includes a rigid casing, and a magnetic disk disposed within the rigid casing. The magnetic disk includes a top surface for storage of data, and a bottom surface for storage of data, the bottom surface including at least a first cylinder and a second cylinder, the second cylinder adjacent the first cylinder, the first cylinder having a first plurality of logically numbered servo bursts including a reference servo burst and a secondary servo burst, the secondary servo burst positioned at an angular displacement relative to the reference servo burst, the second cylinder having a second plurality of logically numbered servo bursts including a reference servo burst located at approximately the angular displacement relative to the reference servo burst of the first cylinder.

### BACKGROUND OF THE INVENTION

The present invention generally relates to removable storage devices for electronic information. More particular, the present invention provides apparatus and methods for enhancing data retrieval from removable storage devices.

Consumer electronics including television sets, personal computers, and stereo or audio systems, have changed dramatically since their availability. Television was originally used as a stand alone unit in the early 1900's, but has now been integrated with audio equipment to provide video with high quality sound in stereo. For instance, a television set can have a high quality display coupled to an audio system with stereo or even “surround sound” or the like. This integration of television and audio equipment provides a user with a high quality video display for an action movie such as STARWARS™ with “life-like” sound from the high quality stereo or surround sound system. Accordingly, the clash between Luke Skywalker and Darth Vader can now be seen as well as heard in surround sound on your own home entertainment center.

In the mid-1990's, computer-like functions became available on a conventional television set. Companies such as WebTV of California provide what is commonly termed as “Internet” access to a television set. The Internet is a world wide network of computers, which can now be accessed through a conventional television set at a user location. Numerous displays or “wet sites” exist on the Internet for viewing and even ordering goods and services at the convenience of home, where the act of indexing through websites is known as “surfing” the web. Accordingly, users of WebTV can surf the Internet or web using a home entertainment center.

As merely an example, FIG. 1 illustrates a conventional audio and video configuration, commonly termed a home entertainment system, which can have Internet access. FIG. 1 is generally a typical home entertainment system, which includes a video display 10 (e.g., television set), an audio output 20, an audio processor 30, a video display processor 40, and a plurality of audio or video data sources 50. Consumers have often been eager to store and play back prerecorded audio (e.g., songs, music) or video using a home entertainment system. Most recently, consumers would like to also store and retrieve information, commonly termed computer data, downloaded from the Internet.

Music or audio have been traditionally recorded on many types of systems using different types of media to provide audio signals to home entertainment systems. For example, these audio systems include a reel to reel system 140 using magnetic recording tape, an eight track player 120 using eight track tapes, a phonograph 130 using LP vinyl records, an audio cassette recorder 110 using audio cassettes, and a digital audio tape (DAT) 90 using DAT cassettes. Optical storage media also have been recognized as providing convenient and high quality audio play-back of music, for example. Optical storage media exclusively for sound include compact disks 10. Unfortunately, these audio systems generally do not have enough memory or capacity to store both video and audio to store full-length movies or the like. Tapes also have not generally been used to efficiently store and retrieve information from a personal computer since tapes are extremely slow and cumbersome.

Audio and video have been recorded together for movies using a video tape or video cassette recorder, which relies upon tapes stored on cassettes. Video cassettes can be found at the local Blockbuster™ store, which often have numerous different movies to be viewed and enjoyed by the user. Unfortunately, these tapes are often too slow and clumsy to store and easily retrieve computer information from a personal computer. Additional video and audio media include a laser disk 70 and a digital video disk 60, which also suffer from being read only, and cannot be easily used to record a video at the user site. Furthermore, standards for a digital video disk (DVDs) have not been established of the filing date of this patent application and do not seem to be readily establishable in the future.

From the above, it is desirable to have a storage media that can be used for all types of information such as audio, video, and digital data, which have features such as a high storage capacity, expandability, and quick access capabilities.

Data Sector Skewing

When moving a magnetic head from a first data track (or data cylinder) to a second data track on a magnetic disk for performing a read or write, a certain amount of time elapses before the magnetic head settles upon the second track. This certain amount of time for adjacent data tracks within the same data zone is known herein as a “skew time”. This skew time is typically much less than the amount of time it takes for one revolution of the magnetic disk. Because the magnetic disk continues to spin while the magnetic head is moving between tracks, a certain amount of measurable displacement occurs during this skew time, such as a linear displacement along the data track, a radial or angular displacement, and the like. As will be described below, to enhance read and write performance of magnetic disks, the placement of data sectors have been skewed between adjacent tracks within data zones to attempt to match this skew time.

As used herein data cylinders or cylinders are different from servo track numbers and gray coded cylinder numbers.

FIG. 7 illustrates a conventional headerless-ID magnetic disk layout having a plurality of data zones. FIG. 7 includes a typical headerless-ID magnetic disk 900 including a plurality of data zones 910-930. Typical data cylinders 940-960 from each respective data zone 910-930 are also illustrated. Cylinders 940-960 are separated into component servo burst signals and data sector signals for convenience.

As illustrated in FIG. 7, the positioning of servo bursts within a track between data zones is slightly staggered to match the natural arc of a read/write head over the magnetic surface.

As is also illustrated in FIG. 7, the width of the servo sectors depend upon the specific data zone. Because magnetic disks typically rotate at a fixed number of revolutions per minute during operation, the servo burst will have approximately the same read time duration whether the servo burst is located in a cylinder at an inner diameter data zone or is located in a cylinder at an outer diameter data zone. Data sectors, in contrast, typically require the same amount of linear magnetic media for storage, thus more data sectors are typically found on cylinders in data zones towards the outer diameter of the magnetic disk. Cylinders within a particular data zone typically include the same number of data sectors.

FIG. 7 also illustrates that the data sectors may be split between two servo bursts. For example, in cylinder 960, data sectors D1 and D4 are split, further, in cylinder 950, data sectors D2 and D7 are split, and in cylinder 940, data sectors D3 and D6 are split. As a result, if the amount of time to read a typical data sector, such as D0 is T, the amount of time to read a typical split data sector, such as D1 on cylinder 960 is T′, where T′>T.

FIG. 8 illustrates data sector skewing of a conventional headerless-ID magnetic disk shown in FIG. 7. FIG. 8 includes cylinders 980 and 990 within the same data zone, separated into component servo burst signals and data sector signals, for convenience. FIG. 8 also illustrates an ideal skew offset 1000, an estimated data sector skew offset 1010, and an actual data sector skew offset 1020.

Data sector skewing is illustrated by comparing the numbered data sectors in cylinder 990 with regards to the data sectors in cylinder 980. Although the servo bursts are substantially aligned as shown in FIG. 7, the data sectors are not aligned in FIG. 8. For example, data sector D0 on cylinder 980 is approximately aligned with data sector D3 on cylinder 990, and data sector D10 on cylinder 980 is approximately aligned with data sector D0 on cylinder 990.

In this example, the idea skew time is the amount of time a read/write head takes to move from cylinder 980 to adjacent cylinder 990. Because, the magnetic disk moves under the read/write heads during this skew time, the skew time is represented by a linear displacement along the data cylinders as ideal skew offset 1000. To calculate the amount of data sector skewing required between adjacent cylinders, i.e. the number of data sectors N to skew between adjacent cylinders, the ideal skew time I is typically divided by the amount of time to read a typical data sector T, therefore N=I/T.

Skewing by N data sectors cannot be used directly without first determining an estimated skewing time. As illustrated in FIG. 7, the number of data sectors per cylinder varies within different data zones, and notably data sectors can be split between different servo bursts. As a result of such data splits, to calculate the estimated skewing time, the amount of time for each data sector is estimated to be T′ not T. By calculation, estimated data sector skew offset 1010=N * T′, or by substitution of N=I/T, estimated data sector skew offset 1010=I * T′/ T.

As an example, if the ideal data sector duration T is 100 microseconds, and the worst case duration T′ is 150 microseconds, the estimated data sector skew offset (T′/T) is 1.5 times the ideal skew offset I. As shown in FIG. 8, estimated data sector skew offset 1010 is longer than ideal skew offset 1000.

The actual amount of data sector skewing includes other delays because of the headerless-ID nature of the data sectors. In this example, estimated data sector skew offset 1010 represents the estimated amount of time it would take a read/write head to settle onto track 990 because of the unpredictability of data sector splits. However, because data sectors do not have IDs, a servo sector burst must first be read before data sectors can be identified once the read/write head settles onto track 990. In this example, servo sector burst 3 must be first read before the data sector D0 can be accessed, therefore the actual data sector skew offset 1020 is longer than ideal skew offset 1000 or estimated data sector skew offset 1010.

Further difficulty arises when attempting to skew data sectors of tracks in different data zones. Because data sectors in different data zones are of different duration, the task of determining the number of data sector skew is quite complex.

In light of the above, what is required are enhanced methods of accessing data that reduces the amount of data latency when moving from one track to another track.

### SUMMARY OF THE INVENTION

According to the present invention, a technique including methods and a device for enhanced data access are disclosed.

According to an embodiment, a removable magnetic cartridge providing enhanced data access includes a rigid casing and a magnetic disk disposed within the rigid casing. The magnetic disk includes a top surface for storage of data and a bottom surface for storage of data. The bottom surface includes at least a first cylinder and a second cylinder, the second cylinder adjacent the first cylinder, the first cylinder includes a first plurality of numbered servo bursts including a reference servo burst and a secondary servo burst, the secondary servo burst positioned at an angular displacement relative to the reference servo burst, the second cylinder having a second plurality of numbered servo bursts including a reference servo burst located at approximately the angular displacement relative to the reference servo burst of the first cylinder.

According to another embodiment, a method for formatting a magnetic disk for a removable magnetic cartridge includes the step of providing the magnetic disk having a top surface and a bottom surface, the top surface having at least a first cylinder and a second cylinder, the second cylinder adjacent to the first cylinder. The steps of writing a first plurality of servo bursts on the first cylinder, the first plurality of servo bursts including a reference servo burst and a secondary servo burst, the secondary servo burst located at an angular displacement on the magnetic disk relative to the reference servo burst, and writing a second plurality of servo bursts on the second cylinder, the second plurality of servo bursts including a reference servo burst, the reference servo burst of the second plurality of servo bursts located at approximately the angular displacement on the magnetic disk relative to the reference servo burst of the first plurality of servo bursts.

According to yet another embodiment, a technique for accessing data from a removable magnetic cartridge having a magnetic disk with a storage device, the magnetic disk including a first data cylinder and a second data cylinder, the first data cylinder having a number of numbered physical servo bursts including a primary physical servo burst and a secondary physical servo burst, the second data cylinder having the number of numbered physical servo bursts including a primary physical servo burst and a secondary physical servo burst, the primary physical servo burst of the second data cylinder substantially radially aligned with the primary physical servo burst of the first data cylinder, the method includes the steps of inserting the removable magnetic cartridge into the storage device, and determining a servo burst skew amount between the first data cylinder and the second data cylinder of the magnetic disk. The method also includes the steps of assigning the primary physical servo burst of the first data cylinder as a primary logical servo burst for the first data cylinder, and assigning the secondary physical servo burst of the second data cylinder as a primary logical servo burst for the second data cylinder in response to the servo burst skew amount. The steps of reading the primary physical servo burst of the first data cylinder with a magneto-resistive head element, determining a location of the magneto-resistive head element as the primary logical servo burst in response to the primary physical servo burst of the first data cylinder, and moving the magneto-resistive head from the first data cylinder to the second data cylinder are also performed. The technique also includes the steps of reading the secondary physical servo burst of the second data cylinder with the magneto-resistive head element, determining a location of the magneto-resistive head element as the primary logical servo burst of the second data cylinder in response to the secondary physical servo burst of the second data cylinder, and accessing the data from the second data cylinder in response to the location of the primary logical servo burst of the second data cylinder.

Numerous benefits are achieved by way of the present invention. The present invention further provides a more reliable method for providing such functions. Depending upon the embodiment, the present invention provides at least one of these if not all of these benefits and others, which are further described throughout the present specification.

Further understanding of the nature and advantages of the invention may be realized by reference to the remaining portions of the specification and drawings.

### BRIEF DESCRIPTION OF THE DRAWINGS

FIG. 1 illustrates a conventional audio and video configuration;

FIG. 2 illustrates a system according to an embodiment of the present invention;

FIG. 3 includes a detailed block diagram of a system 200 according to an embodiment of the present invention;

FIGS. 4A and 4B illustrate a storage unit according to an embodiment of the present invention;

FIGS. 5A-5F illustrate simplified views and a storage unit for reading and/or writing from a removable media cartridge;

FIG. 6 illustrates a functional block diagram of an embodiment of the present invention;

FIG. 7 illustrates a conventional headerless-ID magnetic disk layout having a plurality of data zones;

FIG. 8 illustrates data sector skewing of a conventional headerless-ID;

FIG. 9 illustrates servo sector burst skewing of a headerless-ID magnetic disk;

FIG. 10 illustrates a flow diagram of the present invention; and

FIG. 11 illustrates another embodiment of the present invention.

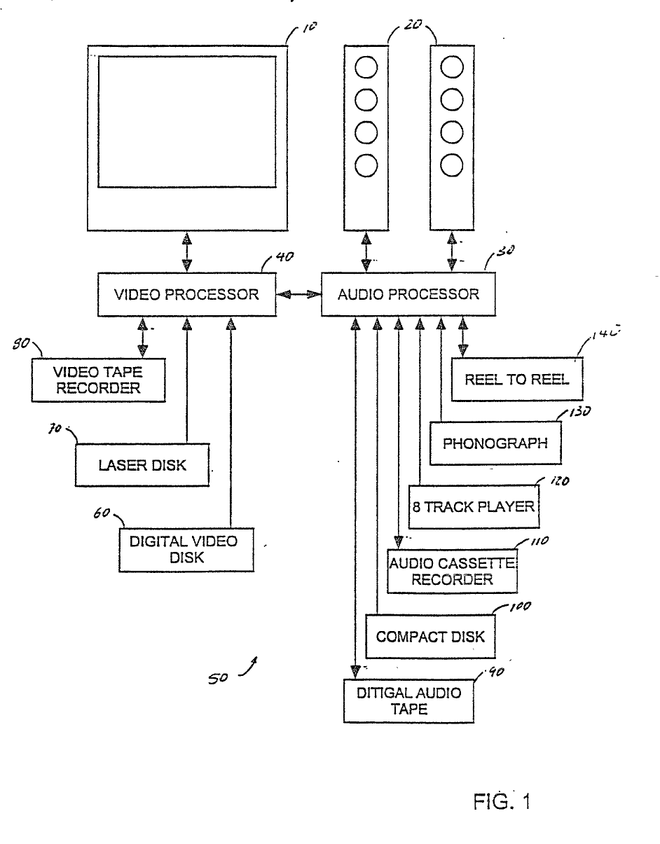

### DESCRIPTION OF SPECIFIC EMBODIMENTS

System Overview

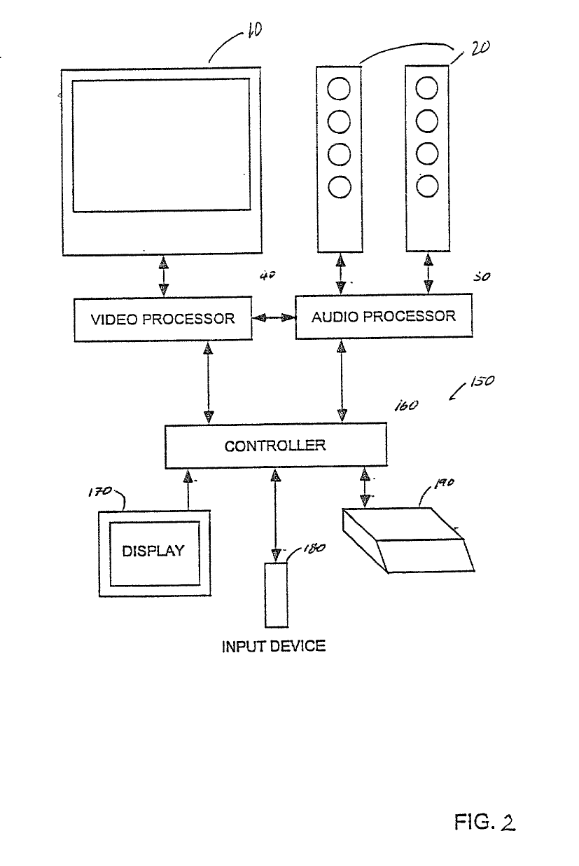

FIG. 2 is a simplified block diagram of a system according to an embodiment of the present invention. This embodiment is merely an illustration and should not limit the scope of the claims herein. The system 150 includes the television display 10, which is capable of Internet access or the like, the audio output 20, a controller 160, a user input device 180, a novel storage unit 190 for storing and accessing data, and optionally a computer display 170. Output from system 150 is often audio and/or video data and/or data that is generally input into audio processor 30 and/or video processor 40.

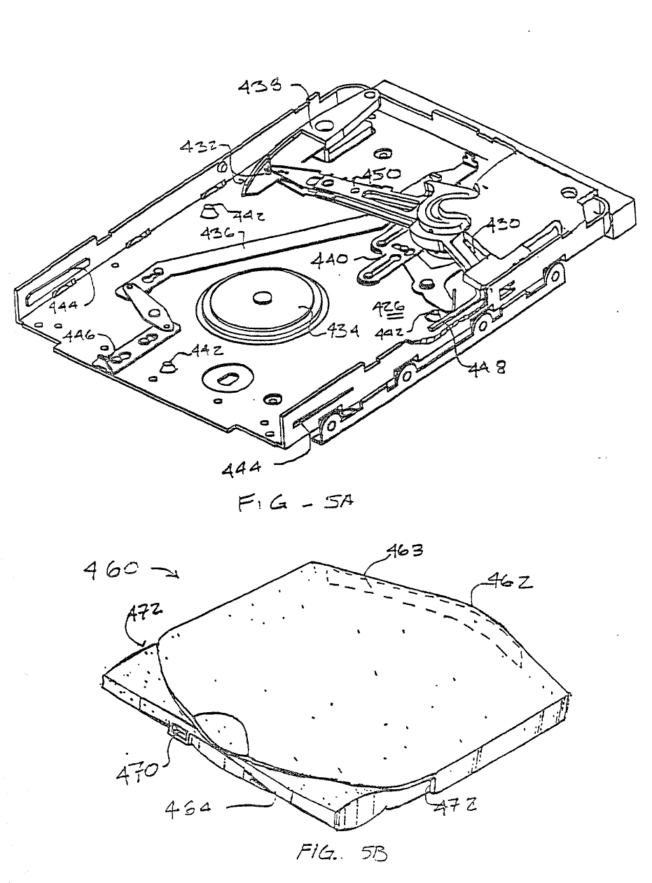

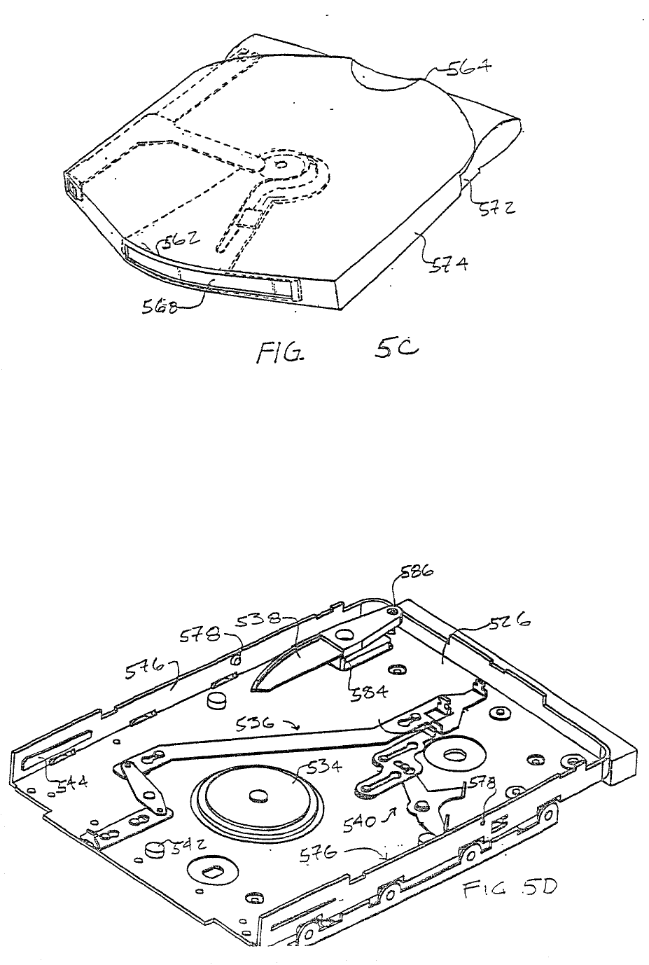

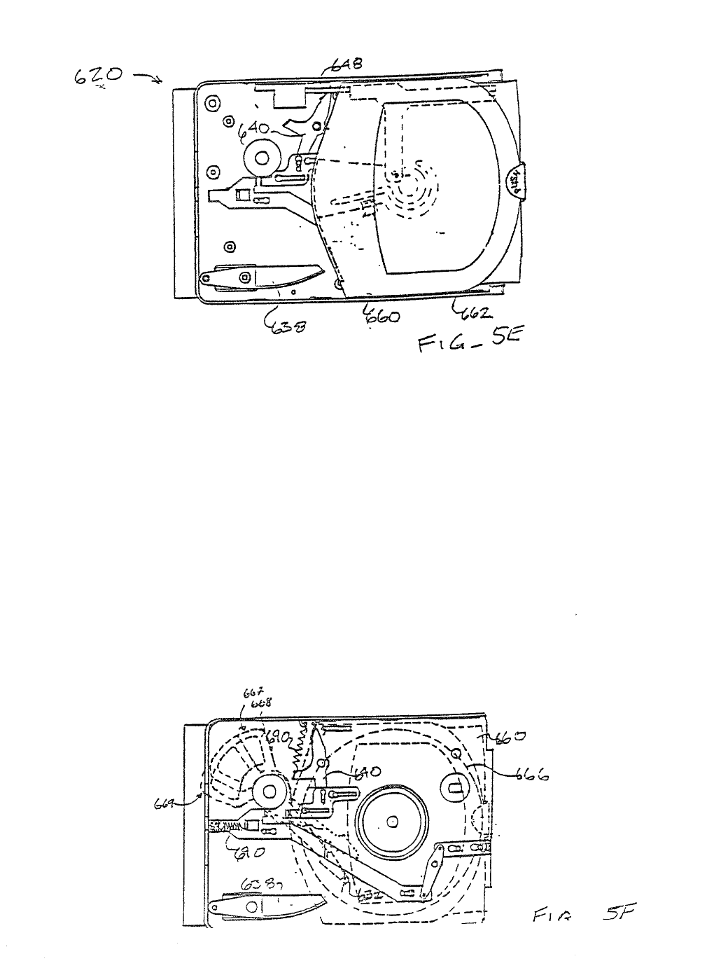

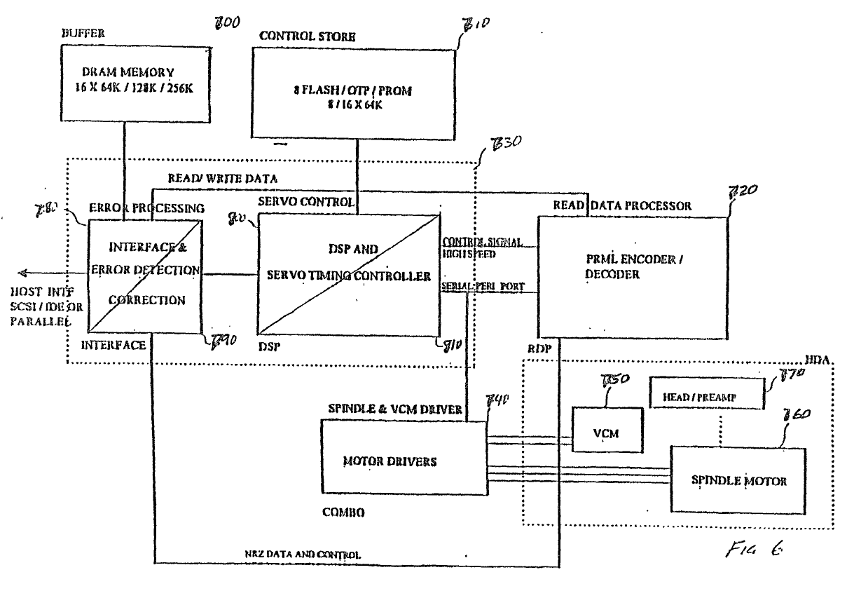

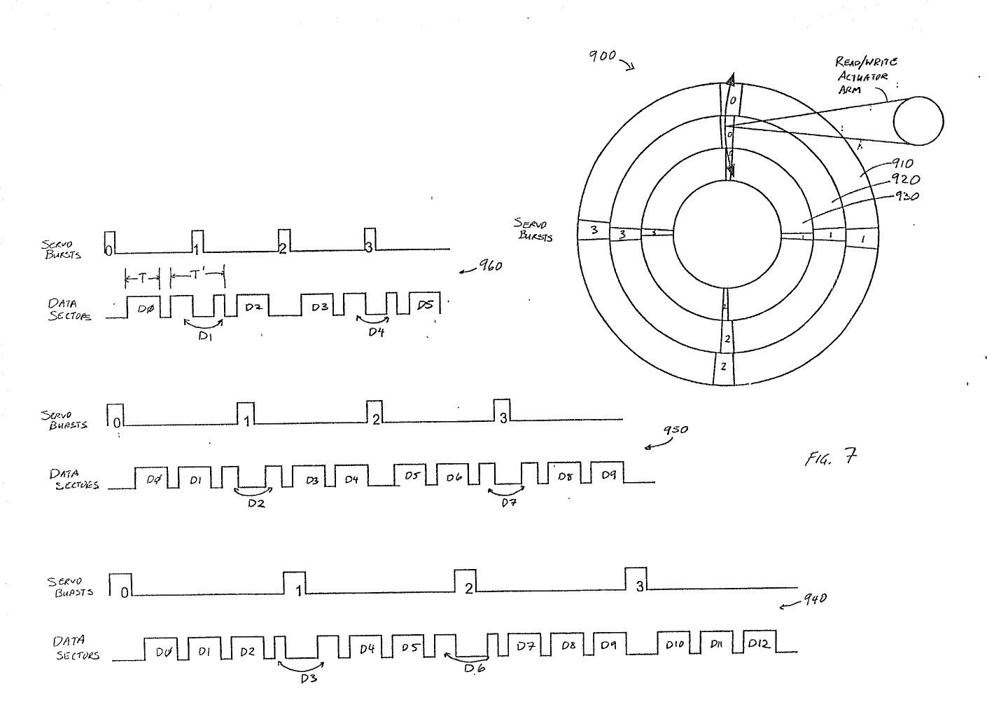

The storage unit includes a high capacity removable media cartridge, such as the one shown in FIGS. 5B & 5C, for example. The removable media cartridge can be used to record and playback information from a video, audio, or computer source. The cartridge is capable of storing at least 2 GB of data or information. The cartridge also has an efficient or fast access time of about 13 ms and less, which is quite useful in storing data for a computer. The cartridge is removable and storable. For example, the cartridge can store up to about 18 songs, which average about 4 minutes in length. Additionally, the cartridge can store at least 0.5 for MPEGII—2 for MPEGI full length movies, which each runs about 2 hours. Furthermore, the cartridge can be easily removed and stored to archive numerous songs, movies, or data from the Internet or the like. Accordingly, the high capacity removable media provides a single unit to store information from the video, audio, or computer. Further details of the storage unit are provided below.

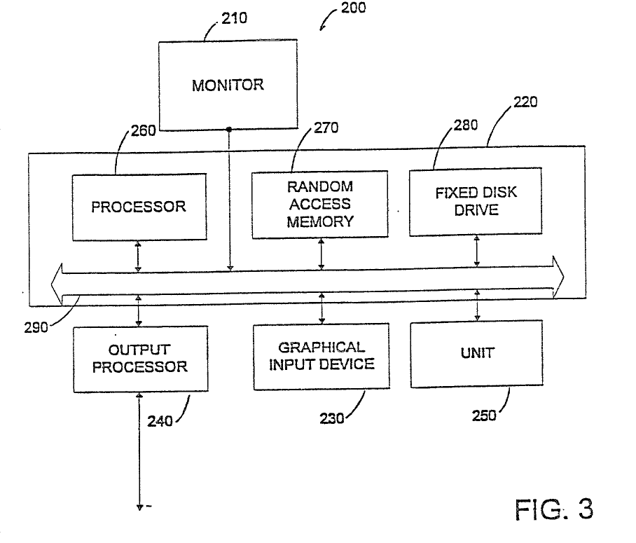

In an alternative embodiment, FIG. 3 is a simplified block diagram of an audio/video/computer system 200. This diagram is merely an illustration and should not limit the scope of the claims herein. The system 200 includes a monitor 210, a controller 220, a user input device 230, an output processor 240, and a novel electronic storage unit 250 preferably for reading and writing from a removable media source, such as a cartridge. Controller 220 preferably includes familiar controller components such as a processor 260, and memory storage devices, such as a random access memory (RAM) 270, a fixed disk drive 280, and a system bus 290 interconnecting the above components.

User input device 230 may include a mouse, a keyboard, a joystick, a digitizing tablet, a wireless controller, or other graphical input devices, and the like. RAM 270 and fixed disk drive 280 are mere examples of tangible media for storage of computer programs and audio and/or video data, other types of tangible media include floppy disks, optical storage media such as CD-ROMs and bar codes, semiconductor memories such as flash memories, read-only-memories (ROMs), ASICs, battery-backed volatile memories, and the like. In a preferred embodiment, controller 220 includes a '586 class microprocessor running Windows95™ operating system from Microsoft Corporation of Redmond, Wash. Of course, other operating systems can also be used depending upon the application.

The systems above are merely examples of configurations, which can be used to embody the present invention. It will be readily apparent to one of ordinary skill in the art that many system types, configurations, and combinations of the above devices are suitable for use in light of the present disclosure. For example, in alternative embodiments of FIG. 2, for example, video display 10 is coupled to controller 220 thus a separate monitor 210 is not required. Further, user input device 230 also utilizes video display 10 for graphical feedback and selection of options. In yet other embodiments controller 220 is integrated directly into either audio processor 20 or video processor 30, thus separate output processor 240 is not needed. In another embodiment, controller 220 is integrated directly into video display 10. Of course, the types of system elements used depend highly upon the application.

Detailed Description

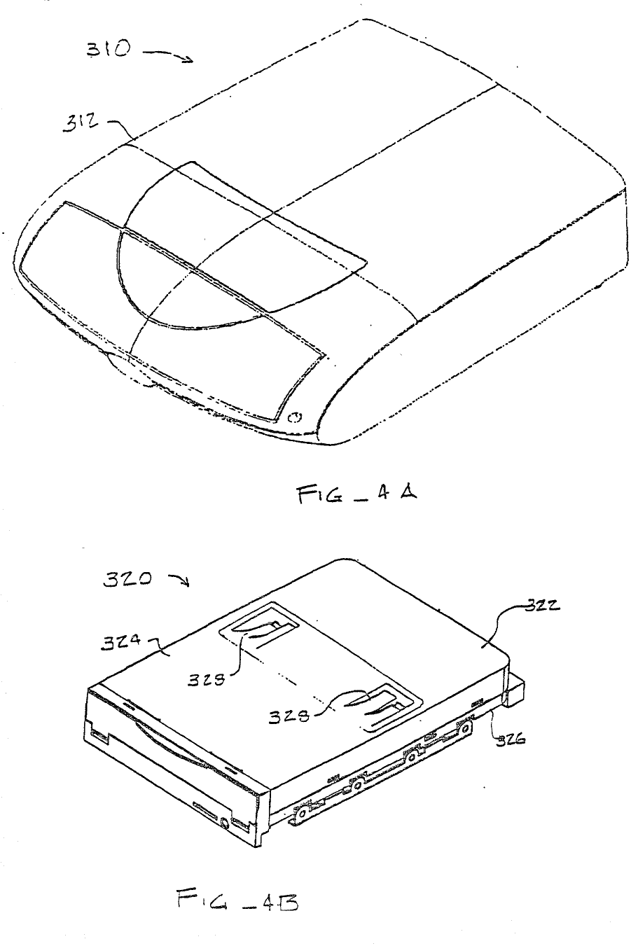

Referring now to FIGS. 4A and 4B, a storage unit according to the present invention can be an external disk drive 310 or internal disk drive 320 unit, which shares many of the same components. However, external drive 310 will include an enclosure 312 adapted for use outside a personal computer, television, or some other data manipulation or display device. Additionally, external drive 310 will include standard I/O connectors, parallel ports, and/or power plugs similar to those of known computer peripheral or video devices.

Internal drive 320 will typically be adapted for insertion into a standard bay of a computer. In some embodiments, internal drive 310 may instead be used within a bay in a television set such as HDTV, thereby providing an integral video system. Internal drive 320 may optionally be adapted for use with a bay having a form factor of 3 inches, 2.5 inches, 1.8 inches, 1 inch, or with any other generally recognized or proprietary bay. Regardless, internal drive 320 will typically have a housing 322 which includes a housing cover 324 and a base plate 326. As illustrated in FIG. 4B, housing 324 will typically include integral springs 328 to bias the cartridge downward within the receiver of housing 322. It should be understood that while external drive 310 may be very different in appearance than internal drive 320, the external drive will preferably make use of base plate 326, cover 324, and most or all mechanical, electromechanical, and electronic components of internal drive 320.

Many of the components of internal drive 320 are visible when cover 322 has been removed, as illustrated in FIG. 5A. In this exemplary embodiment, an actuator 450 having a voice coil motor 430 positions first and second heads 432 along opposed recording surfaces of the hard disk while the disk is spun by spindle drive motor 434. A release linkage 436 is mechanically coupled to voice coil motor 430, so that the voice coil motor effects release of the cartridge from housing 422 when heads 432 move to a release position on a head load ramp 438. Head load ramp 438 is preferably adjustable in height above base plate 426, to facilitate aligning the head load ramp with the rotating disk.

A head retract linkage 440 helps to ensure that heads 432 are retracted from the receptacle and onto head load ramp 438 when the cartridge is removed from housing 422. Head retract linkage 440 may also be used as an inner crash stop to mechanically limit travel of heads 432 toward the hub of the disk.

Base 426 preferably comprise a stainless steel sheet metal structure in which the shape of the base is primarily defined by stamping, the shape ideally being substantially fully defined by the stamping process. Bosses 442 are stamped into base 426 to engage and accurately position lower surfaces of the cartridge housing. To help ensure accurate centering of the cartridge onto spindle drive 434, rails 444 maintain the cartridge above the associated drive spindle until the cartridge is substantially aligned axially above the spindle drive, whereupon the cartridge descends under the influence of cover springs 428 and the downward force imparted by the user. This brings the hub of the disk down substantially normal to the disk into engagement with spindle drive 434. A latch 446 of release linkage 436 engages a detent of the cartridge to restrain the cartridge, and to maintain the orientation of the cartridge within housing 422.

A cartridge for use with internal drive 320 is illustrated in FIGS. 5B and 5C. Generally, cartridge 460 includes a front edge 462 and rear edge 464. A disk 666 (see FIG. 5F) is disposed within cartridge 460, and access to the disk is provided through a door 568. A detent 470 along rear edge 464 of cartridge 460 mates with latch 446 to restrain the cartridge within the receptacle of the drive, while rear side indentations 472 are sized to accommodate side rails 444 to allow cartridge 460 to drop vertically into the receptacle.

Side edges 574 of cartridge 460 are fittingly received between side walls 576 of base 526, as illustrated in FIG. 5D. This generally helps maintain the lateral position of cartridge 460 within base 426 throughout the insertion process. Stops 578 in sidewall 576 stop forward motion of the cartridge once the hub of disk 666 is aligned with spindle drive 534, at which point rails 444 are also aligned with rear indents 472. Hence, the cartridge drops roughly vertically from that position, which helps accurately mate the hub of the disk with the spindle drive.

FIG. 5F also illustrates a typical first position 667 of VCM 668 and a typical second position 669 in response to different magnetic fluxes from a motor driver. As a result, read/write heads 632 are repositioned relative to disk 666 as shown.

FIG. 6 illustrates a simplified functional block diagram of an embodiment of the present invention. FIG. 6 includes a buffer 700, a control store 710, a read data processor 720, a controller 730, motor drivers 740, a voice coil motor 750, a spindle motor 760, and read/write heads 770. Controller 730 includes interface module 780, an error detection and correction module 790, a digital signal processor 800, and a servo timing controller 810. Voice coil motor 750 preferably corresponds to voice coil motor 430 in FIG. 5A, spindle motor 760 preferably corresponds to spindle drive motor 434 in FIG. 5A, and read/write heads 770 preferably correspond to read/write heads 432 on actuator arm 450 in FIG. 5A.

As illustrated in FIG. 6, buffer 700 typically comprises a conventional DRAM, having 16 bits×64K, 128K, or 256K, although other sized buffers are also envisioned. Buffer 700 is typically coupled to error detection and correction module 790. Buffer 700 preferably serves as a storage of data related to a specific removable media cartridge. For example, buffer 700 preferably stores data retrieved from a specific removable media cartridge (typically a magnetic disk), such as media composition and storage characteristics, the location of corrupted locations, the data sector eccentricity of the media, the non-uniformity of the media, the read and write head offset angles for different data sectors of the media and the like. Buffer 700 also preferably stores data necessary to compensate for the specific characteristics of each removable media cartridge, as described above. Buffer 700 typically is embodied as a 1 Meg DRAM from Sanyo, although other vendors' DRAMs may also be used. Other memory types such as SRAM and flash RAM are contemplated in alternative embodiments. Further, other sizes of memory are also contemplated.

Control store 710 typically comprises a readable memory such as a flash RAM, EEPROM, or other types of nonvolatile programmable memory. As illustrated, typically control store 710 comprises a 8 to 16 bit×64K memory array, preferably a flash RAM by Atmel. Control store 710 is coupled to DSP 800 and servo timing controller 810, and typically serves to store programs and other instructions for DSP 800 and servo timing controller 810. Preferably, control store 710 stores access information that enables retrial of the above information from the media and calibration data.

Read data processor 720 typically comprises a Partial Read/Maximum Likelihood (PRML) encoder/decoder. PRML read channel technology is well known, and read data processor 720 is typically embodied as a 81M3010 chip from MARVELL company. Other read data processors, for example from Lucent Technologies are contemplated in alternative embodiments of the present invention. As illustrated, read data processor 720 is coupled to error detection and correction module 790 to provide ECC and data transport functionality.

Interface module 780 typically provides an interface to controller 220, for example. Interfaces include a small computer standard interface (SCSI), an IDE interface, parallel interface, PCI interface or any other known or custom interface. Interface module 780 is typically embodied as an AK-8381 chip from Adaptec, Inc. Interface module 780 is coupled to error detection and correction module 790 for transferring data to and from the host system.

Error detection and correction module 790 is typically embodied as a AIC-8381B chip from Adaptec, Incorporated. This module is coupled by a read/write data line to read data processor 720 for receiving read data and for ECC. This module is also coupled to read data processor 720 by a now return to zero (NRZ) data and control now return to zero line. Other vendor sources of such functionality are contemplated in alternative embodiments of the present invention.

DSP 800 typically provides high-level control of the other modules in FIG. 6. DSP 800 is typically embodied as a AIC-4421A DSP from Adaptec, Inc. As shown, DSP 800 is coupled to read data processor 720 to provide control signals for decoding signals read from a magnetic disk. Further, DSP 800 is coupled to servo timing controller 810 for controlling VCM 750 and spindle motor 760. Other digital signal processors can be used in alternative embodiments, such as DSPs from TI or Motorola.

Servo timing controller 810 is typically coupled by a serial peripheral port to read data processor 720 and to motor drivers 740. Servo timing controller 810 typically controls motor drivers 740 according to servo timing data read from the removable media. Servo timing controller 810 is typically embodied in a portion of DSP800.

Motor driver 740 is typically embodied as a L6260L Chip from SGS-Thomson. Motor driver 740 provides signals to voice coil motor 750 and to spindle motor 760 in order to control the reading and writing of data to the removable media. Spindle motor 760 is typically embodied as an 8 pole Motor from Sankyo Company. Spindle motor 760 typically is coupled to a center hub of the removable media as illustrated in FIG. 4 and rotates the removable media typically at rates from 4500 to 7200 revolutions per minute. Other manufacturers of spindle motor 760 and other rates of revolution are included in alternative embodiments.

VCM 750 is a conventionally formed voice coil motor. Typically VCM 750 includes a pair of parallel permanent magnets, providing a constant magnetic flux. VCM 750 also includes an actuator having a voice coil, and read/write heads. Read/write heads are typically positioned near the end of the actuator arm, as illustrated in FIG. 5A. The voice coil is typically electrically coupled to motor driver 740. VCM 750 is positioned relative to the magnetic disk in response to the amount of current flowing through the voice coil. FIG. 5F illustrates a typical first position 667 of VCM 668 and a typical second position 669 in response to different magnetic fluxes from motor driver 740. As a result, read/write heads 632 are repositioned relative to disk 666 as shown.

In a preferred embodiment of the present invention read/write heads are separate heads that utilize magneto resistive technology. In particular, the MR read/write heads. Typically a preamplifier circuit is coupled to the read/write heads.

In the preferred embodiment of the present embodiment the removable media cartridge is comprises as a removable magnetic disk. When reading or writing data upon the magnetic disk the read/write heads on the end of the actuator arm “fly” above the surface of the magnetic disk. Specifically, because the magnetic disk rotates at a high rate of speed, typically 5400 rpm, a negative pressure pulls the read/write heads towards the magnetic disk, until the read/write heads are typically 0.001 millimeters above the magnetic disk. At 2000 rpm, the negative pressure on the read/write heads drops to approximately half the force as at 5400 rpm.

FIG. 9 illustrates servo sector burst skewing of a headerless-ID magnetic disk. FIG. 9 includes data cylinders 1040 and 1050 within the same data zone, separated into servo burst signals and data sector signals for convenience. FIG. 9 also illustrates an ideal skew offset 1060, and an actual servo burst skew offset 1070.

Servo burst skewing is illustrated by comparing the numbered servo burst in cylinder 1050 to the numbered servo bursts in cylinder 1040. Although the servo bursts are substantially aligned as shown in FIG. 7, the numbering of the servo bursts are not aligned in FIG. 9. For example, servo burst 0 on cylinder 1040 is approximately aligned with servo burst 2 on cylinder 1050, and servo burst 0 on cylinder 1050 is approximately aligned with servo burst 2 on cylinder 1040. Data sectors are typically not skewed relative to the skewed servo bursts, as illustrated, however in alterative embodiments, both servo bursts and data sectors may be skewed advantageously.

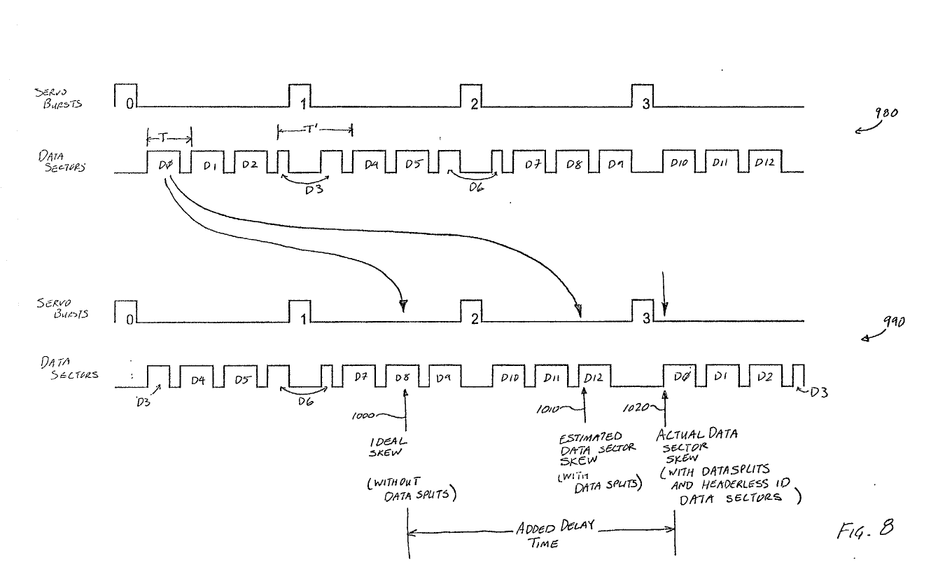

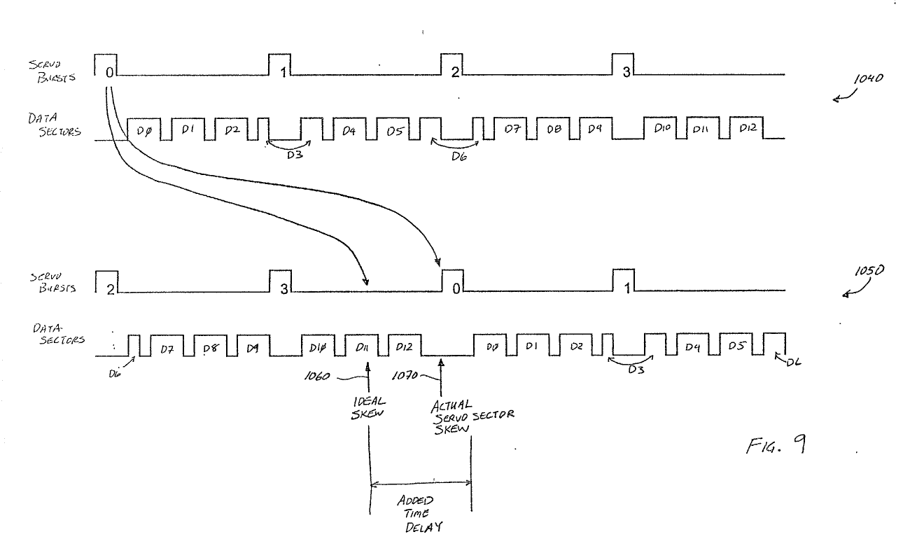

As previously described, ideal skew offset 1060 represents a displacement corresponding to the amount of time a read/write head takes to move from cylinder 1040 to adjacent cylinder 1050. With servo burst skewing, the actual servo burst skew offset 1070 is typically the ideal skew offset 1060 plus a displacement representing the delay until the next servo burst. As can be seen by comparing the examples in FIG. 9, versus FIG. 8, the added delay using a servo burst skewing system is typically less than the delay using a data sector skewing system, because the timing of servo bursts are not affected by data splits. As a result, the performance of a magnetic disk formatted with a servo burst skew is typically higher than the performance of a magnetic disk formatted with a data sector skew.

In the present embodiment, servo burst skewing is calculated for pairs of adjacent cylinders within the same data zone. Thus, for example, if a first track is skewed three servo bursts with relative to an adjacent second track, a third track adjacent to the second servo burst is also skewed three servo bursts relative to the second track, a fourth track adjacent to the third track is skewed three servo bursts relative to the third track, and so on for successive adjacent tracks.

In alternative embodiments, servo burst skewing is performed relative to a selected predetermined track. For example, if the ideal skew amount is slightly less than two and a half servo bursts, a second track may be skewed three servo bursts relative to a first track, a third track may be skewed five servo bursts relative to the first track, a fourth track may be skewed eight servo bursts relative to the first track, and so on.

In embodiments of the present invention, sector skewing occurs between data tracks that belong to different data zones, for example, between the inner-most data track in a data zone and the outer-most data track in the adjacent inner data zone. In such a situation, because the number of servo sectors remains constant between data zones and the duration of servo bursts are relatively constant, servo sector skewing between data zones can be performed.

In the present embodiment, there are approximately 9300 data cylinders per inch and 90 servo bursts per data cylinder.

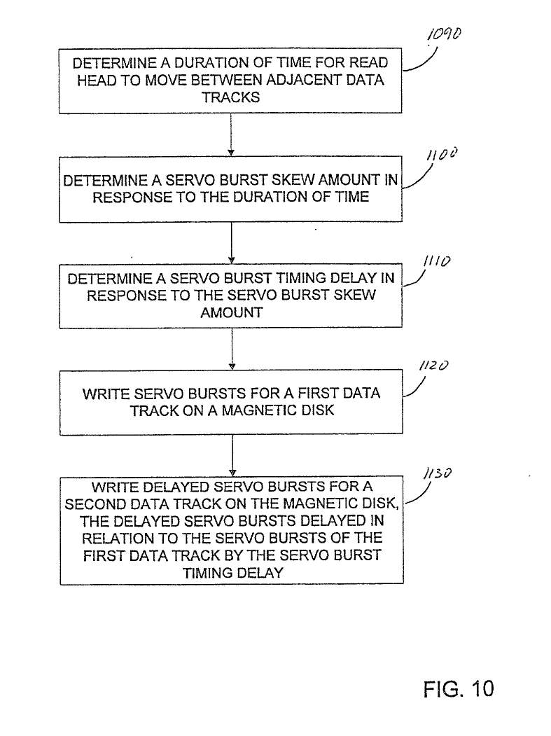

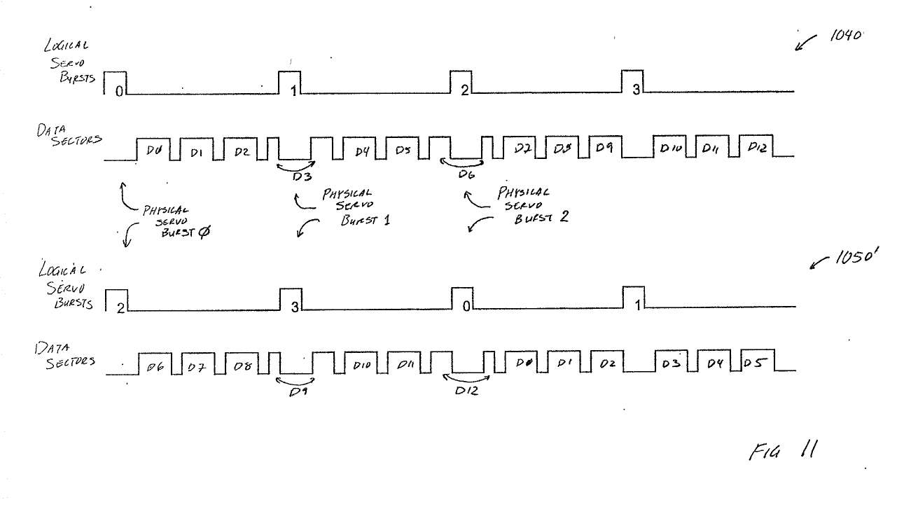

FIG. 10 illustrates a flow diagram of the present invention. In particular, FIG. 10 illustrates a method for formatting cylinders within a data zone with servo bursts. Within a data zone, the position of servo bursts within each cylinder are substantially aligned, however the numbering of the servo burst are skewed, as illustrated in FIG. 9.

Initially, the amount of time an MR head takes to move from one data track to an adjacent data track (ideal skew time) is determined, step 1090. This amount of time is then translated to a servo burst skew amount, step 1110, since the timing between servo bursts is relatively constant. The servo burst skew amount represents the number of servo bursts one cylinder is skewed relative to the adjacent cylinder, as illustrated in FIG. 9. Because each servo burst has an associated numbered, the skew amount can be illustrated by comparing the position of the Nth servo burst of one cylinder to the Nth servo burst of an adjacent cylinder.

In embodiments of the present invention, because the timing between servo bursts in a cylinder is relatively constant regardless of the data zone on the disk, the servo burst skew amount is translated back into a servo burst timing delay, step 1120.

Alternatively, the servo burst skew amount may be translated to a linear displacement along the data track, or translated to an angular displacement from a reference servo burst, typically the zero-th servo burst. In the present embodiment, there are 90 servo bursts per data cylinder, thus skewing by one servo burst yields an angular offset of approximately 4 degrees. Similarly, skewing by three servo bursts yields an angular offset of approximately 12 degrees. Thus, if a reference servo burst of a first track is displaced four servo bursts from a reference servo burst of a second track, the respective reference servo bursts are angularly displaced by approximately 16 degrees. In alternative embodiments of the present invention, a greater or lesser number of servo bursts can be used per data cylinder, thus the angular offsets can vary from above, accordingly.

Any of the above methods: timing, linear media, or angular offset, as well as other methods may be used for purposes for calibrating and writing servo bursts to the magnetic disk, as described below.

Next, the servo bursts for a first data track are written onto a magnetic disk, step 1130. Preferably, the servo bursts within the first data track include associated numbers.

After the servo bursts for the first data track are written, the servo bursts for the second data track are written, incorporating the servo burst skew amount, step 1140. In the present embodiment, the servo bursts within the second data track also include associated numbers. Preferably, the associated numbers of the servo bursts between the first data track and the second data track are offset by the servo burst skew amount.

In one embodiment of the present invention, the associated sector burst numbering, e.g. 0, 1, 2, etc., within a servo burst track are represented with conventional servo burst gray code patterns as is known. In alternative embodiments, the associated sector burst numbering is implemented in the manner described in application Ser. No. 08/970,881, attorney docket No. 18525-002100, entitled Servo-Burst Gray Code Pattern, filed Nov. 14, 1997. This application is herein by incorporated by reference for all purposes.

In one embodiment, the servo bursts for the first data track are written to the magnetic disk, with the 0th servo burst being written first. After completing writing of the first data track, a timer is started and the servo burst writing head moves to the second data track, after the timer has determined that the servo burst timing delay has elapsed, the 0th servo burst for the second data track is written to the magnetic disk. Other methods for writing servo bursts for data tracks are contemplated in other embodiments of the present invention.

For example, in FIG. 11, the servo bursts for each data track begin at the same angular position, however, logically the servo bursts are skewed.

Embodiments of the present invention employ one-third servo track spacing, i.e. there are actually three servo burst tracks associated for each data track, thus each of the servo tracks associated the first data track are typically written in step 1130. Similarly, each of the servo tracks associated the second data track are typically written in step 1130. Further, the embodiments of the present invention include position-burst patterns associated with one-third track spacing, as described in application Ser. No. 60/065,552, attorney docket No. 18525-002000, entitled Improved Position Burst Pattern, filed Nov. 14, 1997. This application is herein by incorporated by reference for all purposes.

In alternative embodiments of the present invention, more conventional one-half servo track spacing can be used. In such embodiments, there are two servo burst tracks associated with each data track.

FIG. 9 illustrates the servo burst offset between the zero-th servo bursts of the first and the second data track. It should be understood that this offset or servo burst skew amount preferably applies to adjacent data tracks within a data zone. For example, the second servo burst in a first data track is substantially aligned with the zero-th servo burst in a second data track, and the third servo burst in the first data track is substantially aligned with the first servo burst in the second data track, etc.

In an embodiment of the present invention, there are 90 servo bursts per track, the typical rotational speed of the magnetic disk is 5400 rpm, and the amount of time for an MR head to settle from one data cylinder to another is approximately 2.5 milliseconds. The typical servo burst skew amounts between adjacent data tracks range from 10 to 30 servo bursts, and more preferably 15 to 25 servo bursts, and more preferably 20 servo bursts. In terms of angular offset, a 20 servo burst skew yields approximately an 80 degrees skew offset between data cylinders 180.

Specific servo burst skew amounts, vary in alternative embodiments of the present invention due to the speed of rotation of the magnetic disk, the speed of repositioning of an MR head on a data track, the specific number of servo sectors bursts on a cylinder, the location of the data zone in the magnetic disk, and the like. Many alterations of the present invention are thus envisioned in alternative embodiments of the present invention.

In the embodiment of the present invention illustrated in FIG. 9, the servo-bursts are skewed by skewing the physical identification marks, e.g. gray codes, of each servo burst. Further in this embodiment, the beginning of the data sectoring begins with the primary servo burst (0th burst).

FIG. 11 illustrates another embodiment of the present invention. In this embodiment the physical identification marks, the gray codes, of each servo burst in a data zone along a radial direction are the same, and the servo burst skewing is performed logically with DSP 800.

In the example in FIG. 11, although logical servo burst 0 in data cylinder 1040′ is aligned with logical servo burst 2 in data cylinder 1050′, in terms of physical identification marks, i.e. the gray codes, physical servo burst 0 in data cylinder 1040′ is still aligned with a physical servo burst 0 in data cylinder 1050′. In such an embodiment, the logical skewing compensation may be performed on the fly by DSP 800 or upon insertion of the magnetic disk.

A predefined table of skewing amounts for DSP 800 may be stored within control store 710 or alternatively, each magnetic disk may include its own custom table of skewing amounts that may be read and used by DSP 800.

As further illustrated in FIG. 11, in one embodiment of the present invention, the location of data sectors does not change between data cylinders. As can be seen, split data sector D3 of data cylinder 1040′ corresponds to split data sector D9 in data cylinder 1050′, and the like.

In another embodiment, the embodiments of FIG. 9 and FIG. 11 can be combined. In such an embodiment, the logical servo bursts are skewed as in FIG. 11, and the data sectors are physically skewed in FIG. 9. Such an embodiment provides a benefit that if the MR read/write moves off of a data track, it can be easily detected because the data sectors between data tracks are not aligned.

Conclusion

In the foregoing specification, the invention has been described with reference to specific exemplary embodiments thereof. Many changes or modifications are readily envisioned. For example, if the speed of rotation of the magnetic disk can vary according to the position of the read/write head on the magnetic disk, thus the amount of servo burst skewing can be based upon the fastest rotation speed as a worst case situation. the presently claimed inventions may also be applied to other areas of technology such as mass storage systems for storage of video data, audio data, textual data, program data, or any computer readable data in any reproducible format.

The specification and drawings are, accordingly, to be regarded in an illustrative rather than a restrictive sense. It will, however, be evident that various modifications and changes may be made thereunto without departing from the broader spirit and scope of the invention.

What is claimed is:

1. A removable magnetic cartridge providing enhanced data access comprising:
a rigid casing; and
a magnetic disk disposed within the rigid casing, comprising:
a top surface for storage of data; and
a bottom surface for storage of data, the bottom surface comprising at least a first cylinder and a second cylinder, the second cylinder adjacent the first cylinder, the first cylinder having a first plurality of logically numbered servo bursts including a primary servo burst and a secondary servo burst, the secondary servo burst positioned at an angular displacement relative to the primary servo burst, the second cylinder having a second plurality of logically numbered servo bursts including a primary servo burst located at approximately the angular displacement relative to the primary servo burst of the first cylinder.

2. The removable magnetic cartridge of claim 1 wherein the angular displacement represents a servo burst skew amount.

3. The removable magnetic cartridge of claim 1
wherein the second cylinder includes a secondary servo burst located at the angular displacement relative to the primary servo burst of the second cylinder, and
wherein the bottom surface also comprises a third cylinder adjacent the second cylinder, the third cylinder including a third plurality of logically numbered servo bursts including a primary servo burst located at approximately the angular displacement relative to the primary servo burst of the second cylinder.

4. The removable magnetic cartridge of claim 1 wherein the primary servo burst of the first cylinder and the secondary servo burst of the first cylinder are separated by at least one servo burst.

5. The removable magnetic cartridge of claim 1 wherein the angular displacement is less than 120 degrees.

6. The removable magnetic cartridge of claim 1 wherein the angular displacement is approximately 80 degrees.

7. The removable magnetic cartridge of claim 1 wherein the first plurality of logically numbered servo bursts is equal to the second plurality of logically numbered servo bursts.

8. A method for formatting a magnetic disk for a removable magnetic cartridge comprising the steps of:
providing the magnetic disk having a top surface and a bottom surface, the top surface having at least a first cylinder and a second cylinder, the second cylinder adjacent to the first cylinder;
writing a first plurality of servo bursts on the first cylinder, the first plurality of servo bursts including a primary servo burst and a secondary servo burst, the secondary servo burst located at an angular displacement on the magnetic disk relative to the primary servo burst; and
writing a second plurality of servo bursts on the second cylinder, the second plurality of servo bursts including a primary servo burst, the primary servo burst of the second plurality of servo bursts located at approximately the angular displacement on the magnetic disk relative to the primary servo burst of the first plurality of servo bursts.

9. The method of claim 8 wherein a number of servo bursts in the first plurality of servo bursts is equal to a number of servo bursts in the second plurality of servo bursts.

10. The method of claim 8 wherein the primary servo burst and the secondary servo burst of the first plurality of servo bursts are separated by at least one of the first plurality of servo bursts.

11. The method of claim 8 wherein the angular displacement is less than approximately 80 degrees.

12. The method of claim 8 wherein the angular displacement represents a servo burst skew amount between the first cylinder and the second cylinder.

13. The method of claim 12 further comprising the step of:
before the writing steps, determining the servo burst skew amount.

14. A method for accessing data from a removable magnetic cartridge having a magnetic disk with a storage device, the magnetic disk including a first data cylinder and a second data cylinder, the first data cylinder having a number of numbered physical servo bursts including a primary physical servo burst and a secondary physical servo burst, the second data cylinder having the number of numbered physical servo bursts including a primary physical servo burst and a secondary physical servo burst, the primary physical servo burst of the second data cylinder substantially radially aligned with the primary physical servo burst of the first data cylinder, the method comprising the steps of:
inserting the removable magnetic cartridge into the storage device;
determining a servo burst skew amount between the first data cylinder and the second data cylinder of the magnetic disk;
assigning the primary physical servo burst of the first data cylinder as a primary logical servo burst for the first data cylinder;
assigning the secondary physical servo burst of the second data cylinder as a primary logical servo burst for the second data cylinder in response to the servo burst skew amount;
reading the primary physical servo burst of the first data cylinder with a magneto-resistive head element;
determining a location of the magneto-resistive head element as the primary logical servo burst in response to the primary physical servo burst of the first data cylinder;
moving the magneto-resistive head from the first data cylinder to the second data cylinder;
reading the secondary physical servo burst of the second data cylinder with the magneto-resistive head element;
determining a location of the magneto-resistive head element as the primary logical servo burst of the second data cylinder in response to the secondary physical servo burst of the second data cylinder; and
accessing the data from the second data cylinder in response to the location of the primary logical servo burst of the second data cylinder.

15. The method of claim 14 wherein the step of determining a servo burst skew amount comprises the step of retrieving the servo burst skew amount from a memory within the storage device.

16. The method of claim 14 wherein the step of determining a servo burst skew amount comprises the step of retrieving the servo burst skew amount from the magnetic disk.

18. The method of claim 14 wherein the servo burst skew amount is a number of physical servo bursts.

19. The method of claim 18 wherein the number of physical servo bursts is approximately 20.

20. The method of claim 14 wherein the number of numbered physical servo bursts is greater than 80.
